(19) United States
(12) Patent Application Publication
(10) Pub. No.: US 2014/0129485 A1
(43) Pub. Date: May 8, 2014

(54) Display Apparatus

(71) Applicant: Geoff Fisher, San Marcos, CA (US)

(72) Inventor: Geoff Fisher, San Marcos, CA (US)

(21) Appl. No.: 14/073,534

(22) Filed: Nov. 6, 2013

Related U.S. Application Data
(60) Provisional application No. 61/723,149, filed on Nov. 6, 2012.

(51) Int. Cl. G06Q 90/00; A47F 7/00

(52) U.S. Cl. CPC G06Q 90/00; A47F 7/0035
USPC 705/500; 211/85.7

(57) ABSTRACT

Described herein are apparatus for mounting and/or displaying elongated sporting boards. Also described are methods of selling elongated sporting boards at self service retailers.

### CROSS REFERENCE TO RELATED APPLICATIONS

This application claims the benefit of U.S. provisional patent application No. 61/723,149, filed Nov. 6, 2012, the entire disclosure of which is incorporated herein by reference.

### BACKGROUND

Generally, selling goods without the aid of onsite staff possessing particular knowledge of the goods can be challenging. Further, for large odd shaped goods, the task can be even more challenging as costs associated with transport, storage and retail floor space can be issues.

As such, in many retail areas, again where local knowledge of the good may be lacking, there is a need for display methods that can aid in the retail appeal, sellability, space conservation, transport and/or staging of a good. Described below are apparatuses and methods that can accomplish these tasks.

### SUMMARY

Described generally are mobile elongated sporting board rack systems comprising: a frame including a top deck configured to horizontally support a first elongated sporting board in an orientation of use and at least two angled side decks each independently configured to horizontally support an additional elongated sporting board in a presentation orientation; and at least one wheel configured for mobility.

In another embodiment, the frames can include: (a) a top deck configured to horizontally support a first elongated sporting board in an orientation of use; (b) a first angled side deck configured to horizontally support a second elongated sporting board in a first presentation orientation; and (c) a second angled side deck configured to horizontally support a third elongated sporting board in a second presentation orientation.

Also described are methods of selling elongated sporting boards in a self service retailer comprising: displaying to a buyer the elongated sporting board on a self selling display frame including a top deck configured to horizontally support a first elongated sporting board in an orientation of use and at least two angled side decks each independently configured to horizontally support an additional elongated sporting board in a presentation orientation; and selling the at least one elongated sporting board to the buyer with minimal or less than minimal input from the self service retailer.

Other methods are described for of presenting elongated sporting boards in a self service retailer comprising: providing a self selling display frame including: a top deck configured to horizontally support a first elongated sporting board in an orientation of use; a first angled side deck configured to horizontally support a second elongated sporting board in a first presentation orientation; and a second angled side deck configured to horizontally support a third elongated sporting board in a second presentation orientation; presenting a buyer with an information pamphlet about the first elongated sporting board, the second elongated sporting board, and the third elongated sporting board; and selling the at least one elongated sporting board to a buyer with minimal or less than minimal input from the self service retailer.

The frames described herein can include at least one arm configured to mount an accessory or configured as a handle for moving the apparatus from one place to another. The frames can also include at least one pair of accessory hangers. For example, the at least one pair of accessory hangers can be configured to mount an oar. Further still, the frames can include an adjustable length cross beam between two masts, wherein the masts mountably attach hangers, arms and wheels. For example, the angled side decks mounted to the masts can be oriented at an angle of between about 20 degrees and about 60 relative to perpendicular to the top deck. Any location on a frame can include protection for elongated sporting boards that may touch the frame.

A self service retailer as used herein can be a warehouse or a military exchange where little information about a product may be available. As such, information pamphlets can be further displayed to the buyer to aid in educating that buyer.

An elongated sporting board can be, but is not limited to a surfboard, a paddle board, a boogie board, a wake board, a knee board, a skim board, a snowboard, a skateboard, a roller board, a sled, or a combination thereof.

In one embodiment, a system described herein can mount three elongated sporting boards. In another embodiment, a system described herein can mount five elongated sporting boards. For example, in one embodiment, the frames described can further include a third angled side deck configured to horizontally support a fourth elongated sporting board in a third presentation orientation; and a fourth angled side deck configured to horizontally support a fifth elongated sporting board in a fourth presentation orientation.

Other methods of displaying an elongated sporting board in a self service retailer comprising: mounting at least one elongated sporting board on a self selling display frame including: (a) a top deck configured to horizontally support a first elongated sporting board in an orientation of use; (b) a first angled side deck configured to horizontally support a second elongated sporting board in a first presentation orientation; (c) a second angled side deck configured to horizontally support a third elongated sporting board in a second presentation orientation; and (d) at least two wheels attached to the self selling display frame; rolling the self selling display frame to a desired store location within the self service retailer; providing minimal or less than minimal input from the self service retailer about the at least one elongated sporting board; and selling the at least one elongated sporting board to a buyer.

The apparatus and displays described herein can also be used for personal use at a beach or other body of water or to transport elongated sporting boards.

### BRIEF DESCRIPTION OF THE DRAWINGS

FIG. 1 illustrates a perspective view of an apparatus according to the present description.

FIG. 2 illustrates an exploded perspective view of the apparatus of FIG. 1.

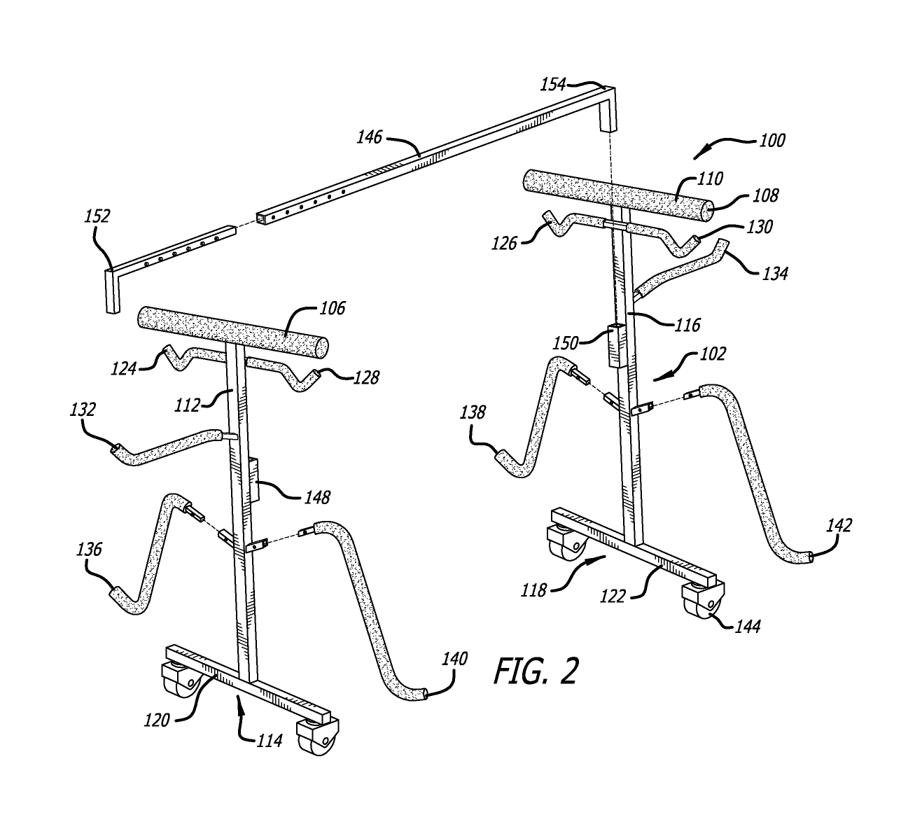

FIG. 3 illustrates a side view of the apparatus of FIG. 1.

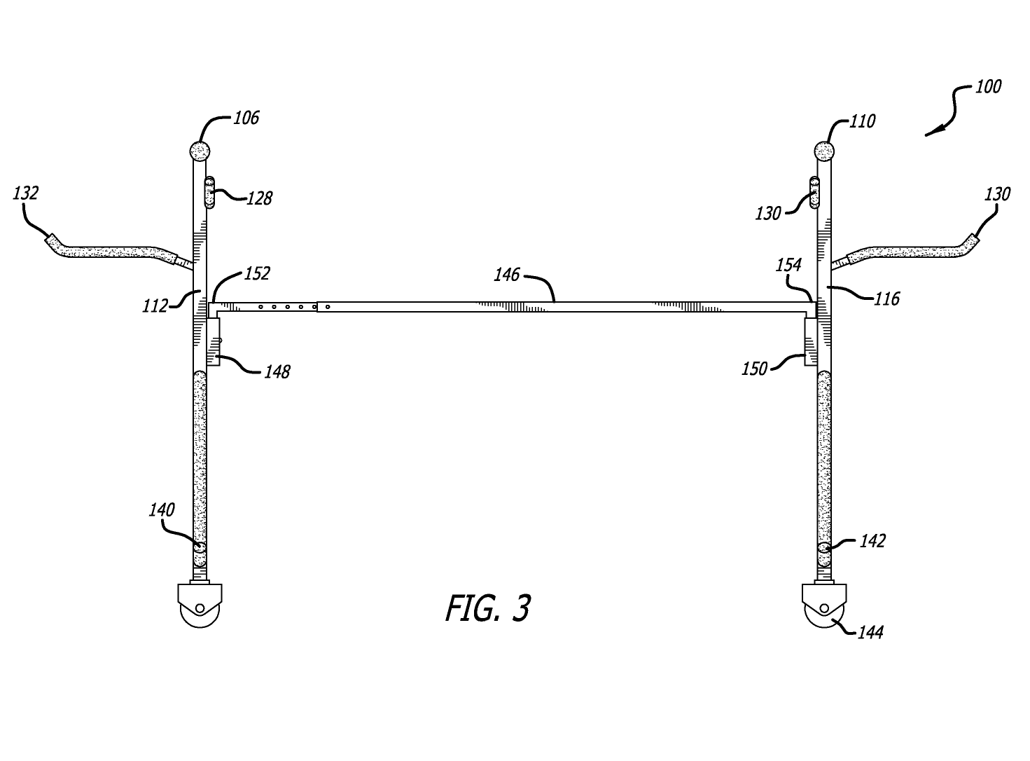

FIG. 4 illustrates a top view of the apparatus of FIG. 1.

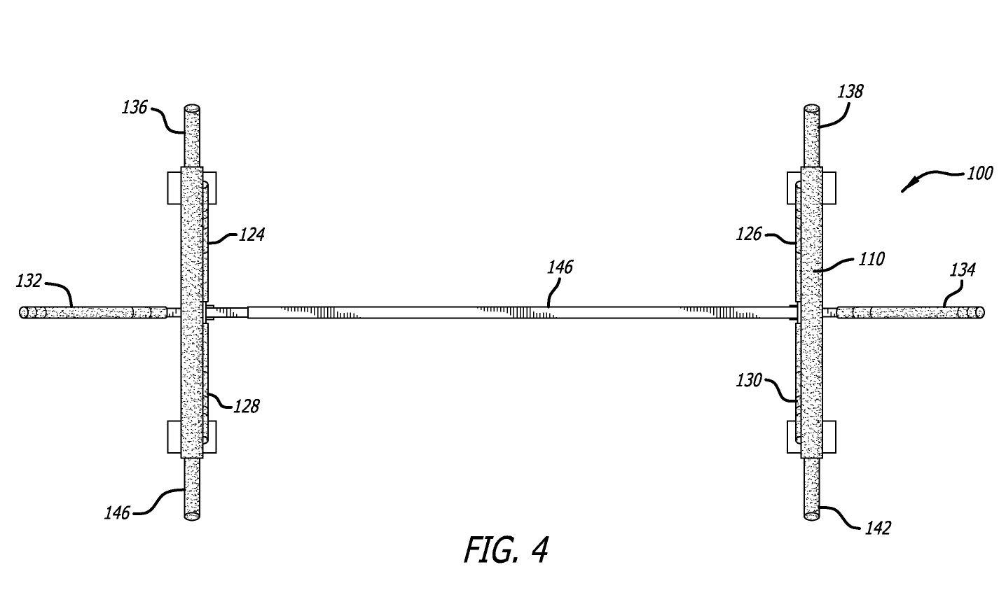

FIG. 5 illustrates a perspective view of an apparatus including three elongated sporting boards and accessories.

FIG. 6 illustrates a front view of the apparatus of FIG. 5 including three elongated sporting boards and accessories.

FIG. 7 illustrates a side view of an apparatus including three elongated sporting boards and accessories as well as a mannequin displayed in a position of use.

FIG. 8 illustrates a perspective view of an alternate apparatus including five elongated sporting boards and accessories.

FIG. 9 illustrates a front view of the alternate apparatus of FIG. 8 including five elongated sporting boards and accessories.

### DETAILED DESCRIPTION

Described are apparatuses for displaying, selling, transporting, storing, and/or mounting at least one elongated sporting board. Methods of using the apparatus for the above purposes are also described.

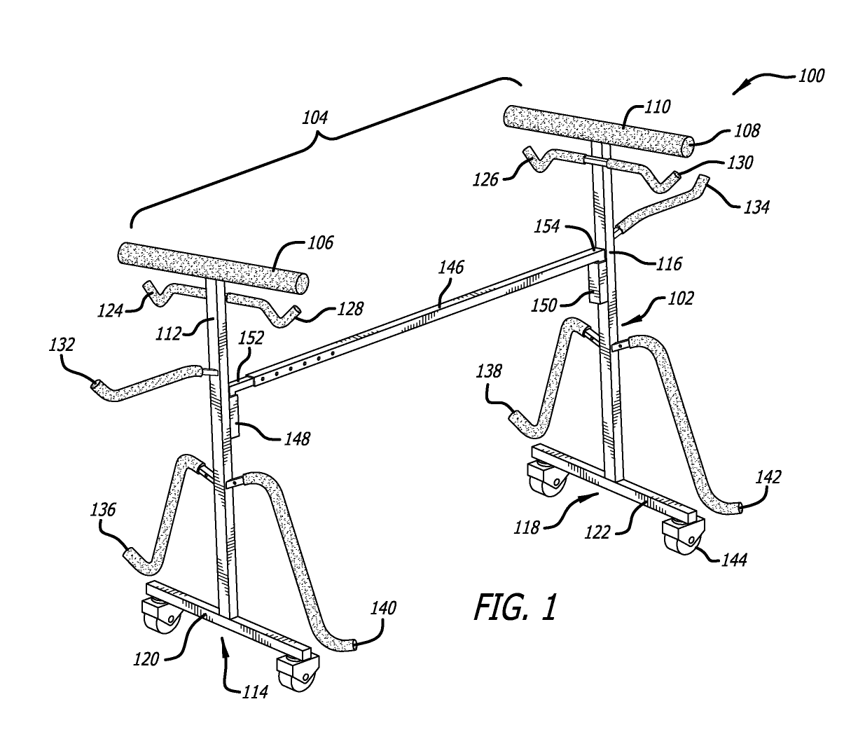

Generally, apparatus 100 in FIG. 1 can at least aid in the displaying, selling, transporting, storing, and/or mounting of at least one piece of elongated sporting equipment. Elongated sporting equipment can be any piece of equipment that is longer than about 3 ft, about 4 ft, about 5, ft, about 6 ft, about 7 ft, about 8 ft, or longer. Such equipment can include, but is not limited to surfboards, paddle boards, boogie boards, wake boards, knee boards, skim boards, snow shoes, water skies, kayaks, crew boats, snowboards, snow skies, skateboards, roller boards, sleds, toboggans, luges, oars, swords, pool cues, golf clubs, bows, guns, fishing poles, baseball bats, cricket bats, hockey sticks, lacrosse sticks, tennis racquets, swords, bows, staffs, sabers, pole vault poles, semitars, shives, bayonets, jousting sticks, axes, canoes, exercise mats, prosthesis, banana boats, and the like. In one embodiment, the

In one embodiment, elongated sporting equipment can include elongated sporting boards which can be any piece of elongated sporting equipment that resembles the general shape of a board. Such equipment can include, but is not limited to surfboards, paddle boards, boogie boards, wake boards, knee boards, skim boards, snowboards, skateboards, roller boards, sleds, and the like.

Apparatus 100 can include frame 102. Frame 102 can be configured to hold at least one piece of elongated sporting equipment.

Frame 102 can be formed of any material that can withstand the desired weight capacities. Materials can include, but are not limited to aluminum, copper, brass, nickel, titanium, iron, steel, stainless steel, carbon fiber, plastic, fiberglass, or a combination thereof. For example, frame 102 can be formed of metal, plastic or the like. The metal or plastic can be solid or hollow, cylindrical or square in cross-section, and/or coated or uncoated. Further, frame 102 can include portions that are covered with a foam-like material or a soft polymeric material that protects equipment being displayed.

Frame 102 can further include top deck area 104 configured to horizontally support a first elongated sporting equipment piece. In one embodiment, the first elongated sporting equipment piece is a sporting board in an orientation of use. In another embodiment, the first elongated sporting equipment piece is a surfboard or paddle board in an orientation of use.

Top deck area can be created by first perpendicular bar 106 and second perpendicular bar 108. Each of first perpendicular bar 106 and second perpendicular bar 108 can include a foam cover 110. First perpendicular bar 106 and second perpendicular bar 108 can be about 1 ft, about 2 ft, about 3 ft, about 4 ft, about 5 ft, about 6 ft, between about 1 ft and about 6 ft, between about 1 ft and about 4 ft, or between about 1 ft and about 2 ft in length.

Further, each of first perpendicular bar 106 and second perpendicular bar 108 is supported by first mast 112 located at first end 114 and second mast 116 located at second end 118 respectively. First mast 112 and second mast 116 are attached to first base 120 and second base 122.

First mast 112 and second mast 116 can be about 1 ft, about 2 ft, about 3 ft, about 4 ft, about 5 ft, about 6 ft, about 7 ft, about 8 ft, about 9 ft, about 10 ft, about 11 ft, about 12 ft, about 13 ft, about 14 ft, about 15 ft, about 16 ft, about 17 ft, about 18 ft, about 19 ft, about 20 ft, between about 1 ft and about 10 ft, between about 1 ft and about 7 ft, between about 1 ft and about 4 ft, between about 4 ft and about 7 ft, between about 2 ft and about 8 ft, between about 3 ft and about 10 ft, or between about 2 ft and about 10 ft tall.

First mast 112 and second mast 116 can each optionally include many features. For example, first accessory hanger 124, second accessory hanger 126, third accessory hanger 128, and fourth accessory hanger 130 can be attached to either first mast 112, second mast 116, or both. Each accessory hanger can be used to hang one or more accessories, or two hangers can be used in conjunction to hold a longer accessory in a horizontal configuration. One example accessory can be an oar for a paddle board.

In one embodiment, each accessory hanger can be covered in a polymeric material for protection of elongated sporting equipment or accessories supported or mounted on the frames.

First arm 132 and second arm 134 can be removeably attached to first mast 112 and second mast 116. First arm 132 and second arm 134 may be any suitable shape. For example, first arm 132 and second arm 134 can take may different shapes such as that illustrated in FIG. 1, a handle to aid in transport of apparatus 100, a loop, a hook, or the like. In one embodiment, first arm 132 and second arm 134 may not be included.

First mast 112 and second mast 116 can further include portions attached to them. For example, first angled elongated equipment deck support 136, second angled elongated equipment deck support 138, third angled elongated equipment deck support 140, and fourth angled elongated equipment deck support 142 can be attached to first mast 112 and second mast 116. Each angled elongated equipment deck support can be used to hang one or more portions of an elongated equipment piece, or two deck supports can be used in conjunction to hold an entire piece of elongated equipment.

Each angled elongated equipment deck support may have any suitable shape that can support an elongated sporting board or piece of elongated sporting equipment. For example, each angled elongated equipment deck support can be have an elongated “s” shape including an attachment end for attaching to a mast and a retainment end for retaining an elongated sporting board. The linear portion of the elongated “s” shape can serve to allow elongated sporting boards to rest against it. This linear portion can be about 1 ft, about 2 ft, about 3 ft, about 4 ft, between about 1 ft and about 4 ft, between about 1 ft and about 3 ft, or between about 1 ft and about 2 ft in length.

Each angled elongated equipment deck support can be configured to hold a total weight of at least about 2 lbs, at least about 10 lbs, at least about 35 lbs, at least about 50 lbs, at least about 100 lbs, at least about 200 lbs, at least about 300 lbs, at least about 400 lbs, about 2 lbs, about 5 lbs, about 10 lbs, about 15 lbs, about 25 lbs, about 50 lbs, about 75 lbs, about 100 lbs, about 200 lbs, about 300 lbs, about 400 lbs, about 500 lbs, about 600 lbs, between about 2 lbs and about 50 lbs, between about 2 lbs and about 25 lbs, between about 2 lbs and about 10 lbs, between about 2 lbs and about 600 lbs, or between about 5 lbs and about 10 lbs.

Each of first base 120 and second base 122 can include at least one wheel 144 for easy transport of apparatus 100. For example, in one embodiment, first base 120 can include at least one first wheel and second base 122 can include at least one second wheel. Each of first base 120 and second base 122 can include one wheel, two wheels, three wheels, or four wheels. In other embodiments, no wheels are included and stationary feet are included on first base 120 and second base 122.

The wheels used can depend on the potential use of apparatus 100. For example for in store display purposes, four wheels, two on each base, can be used for mobility. The wheels can be ball bearing wheels with built on brakes. Alternately, if used for outdoor sporting purposes, rubber inflatable wheels can be used for ease of mobility in more rugged terrain. Further, if used for storage on beach sand, long spikes can be used that bury into the sand. Further still, in one embodiment, if a handle is included on a frame described herein, two wheels can be situated on the opposite base and pegs can be placed on the adjacent base allowing for the frame to roll on the two wheels when tilted off the ground on the side of the pegs. Four wheels can also be used if the frame includes a handle. Any number or kind of wheels can be used depending on the circumstances and intended use of apparatus 100.

First mast 112 and second mast 116 can be operatively connected using a cross beam 146. Cross beam 146 can be attached to first mast 112 at first releasable receiver portion 148, or attachment point, and second mast 116 at second releasable attachment point 150. Attachment points can include any attachable means that can securely attach the parts. In one embodiment, cross bean 146 can include a perpendicular first end 152 and a perpendicular second end 154 that slide into a first channel at first releasable attachment point 148 and a second channel at second releasable attachment point 150 respectively. The parts can be secured together using a spring pin and hole combination.

Cross beam 146 can have an adjustable length. In other embodiments, the length can be fixed. If adjustable, cross beam 146 can have at least two, at least three, at least four, at least five, at least six, at least seven, at least eight, at least nine, at least ten, at least eleven, at least twelve, two, three, four, five, six, seven, eight, nine, ten, eleven, twelve different adjustable positions. Lengths of cross beam 146 can include about 1 ft, about 2 ft, about 3 ft, about 4 ft, about 5 ft, about 6 ft, about 7 ft, about 8 ft, about 9 ft, about 10 ft, about 11 ft, about 12 ft, between about 1 ft and about 3 ft, between about 2 ft and about 3 ft, between about 2 ft and about 5 ft, between about 1 ft and about 5 ft, between about 1 ft and about 12 ft, between about 1 ft and about 10 ft, or between about 3 ft and about 6 ft. Different length positions can be adjusted using a spring pin and hole combination.

Apparatus 100 can be configured to hold a total weight of at least about 25 lbs, at least about 50 lbs, at least about 75 lbs, at least about 100 lbs, at least about 200 lbs, at least about 300 lbs, at least about 400 lbs, at least about 500 lbs, at least about 600 lbs, at least about 700 lbs, at least about 800 lbs, at least about 900 lbs, at least about 1,000 lbs, about 25 lbs, about 50 lbs, about 75 lbs, about 100 lbs, about 200 lbs, about 300 lbs, about 400 lbs, about 500 lbs, about 600 lbs, about 700 lbs, about 800 lbs, about 900 lbs, about 1,000 lbs, about 1,200 lbs, or about 1,400 lbs.

Top deck can be configured to hold a total weight of at least about 25 lbs, at least about 50 lbs, at least about 75 lbs, at least about 100 lbs, at least about 200 lbs, at least about 300 lbs, at least about 400 lbs, at least about 500 lbs, about 25 lbs, about 50 lbs, about 75 lbs, about 100 lbs, about 200 lbs, about 300 lbs, about 400 lbs, about 500 lbs, or about 600 lbs.

Total weight on each angled side deck can be configured to hold a total weight of at least about 25 lbs, at least about 50 lbs, at least about 75 lbs, at least about 100 lbs, at least about 200 lbs, at least about 300 lbs, about 25 lbs, about 50 lbs, about 75 lbs, about 100 lbs, about 200 lbs, about 300 lbs, or about 400 lbs.

Total weight of apparatus 100 can vary depending on the particular configuration used. Hollow tubing can be used to form the frame to reduce the overall weight. Apparatus 100 can be light in order to aid in mobility loaded with product. In general, apparatus 100 alone can have a weight of less than about 300 lbs, less than about 200 lbs, less than about 100 lbs, less than about 50 lbs, less than about 25 lbs, or less than about 15 lbs.

Apparatus 100 can further disassemble or “break down” or order to more easily transport it. For example, in one embodiment, cross beam 146 can disconnect from first mast 112 and second mast 116, first angled elongated equipment deck support 136 and second angled elongated equipment deck support 138 can disconnect from first mast 112, third angled elongated equipment deck support 140 and fourth angled elongated equipment deck support 142 can disconnect from second mast 116, and the components can stack in a condensed area compared to the assembled apparatus.

In some embodiments, apparatus 100 can condense into a space of about 2.5 ft³, about 2.6 ft³, about 2.7 ft³, about 2.8 ft³, about 2.9 ft³, about 3.0 ft³, about 3.1 ft³, about 3.2 ft³, about 3.3 ft³, about 3.4 ft³, about 3.5 ft³, about 3.6 ft³, about 3.7 ft³, about 3.8 ft³, about 3.9 ft³, about 4.0 ft³, less than about 4.0 ft³, less than about 3.5 ft³, less than about 3.2 ft³, less than about 3.0 ft³, between about 2.5 ft³ and about 4.0 ft³, between about 2.9 ft³ and about 3.1 ft³, or between about 2.5 ft³ and about 3.5 ft³. In one embodiment, when compacted, apparatus 100 can fit into a trunk of a compact car.

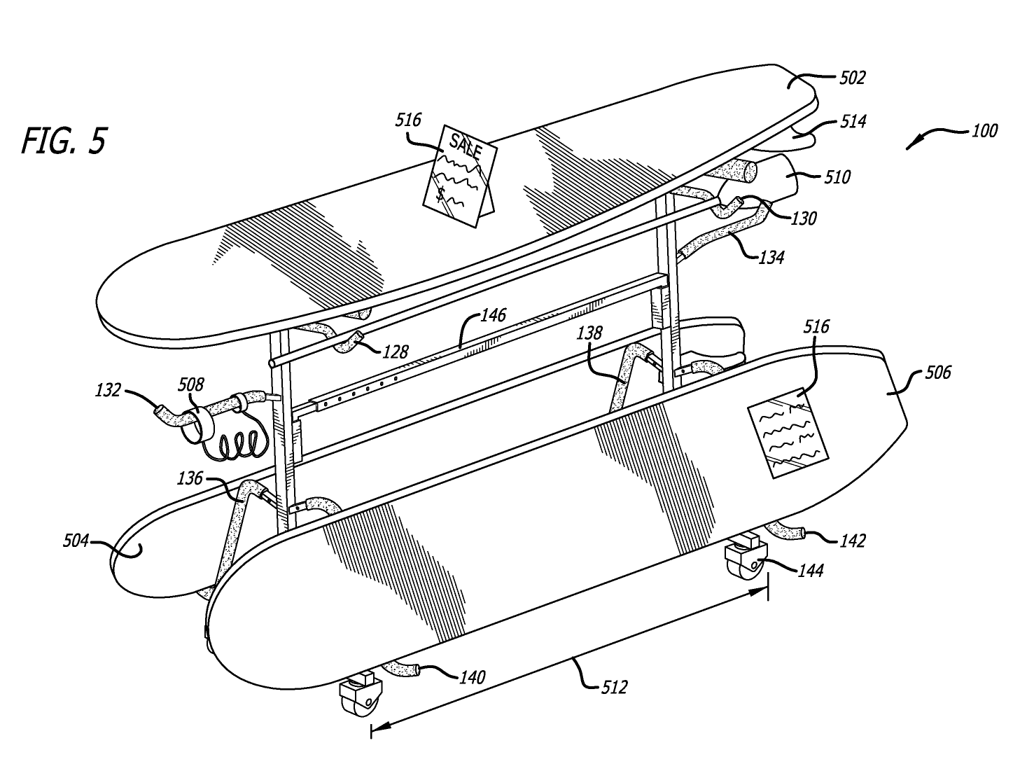

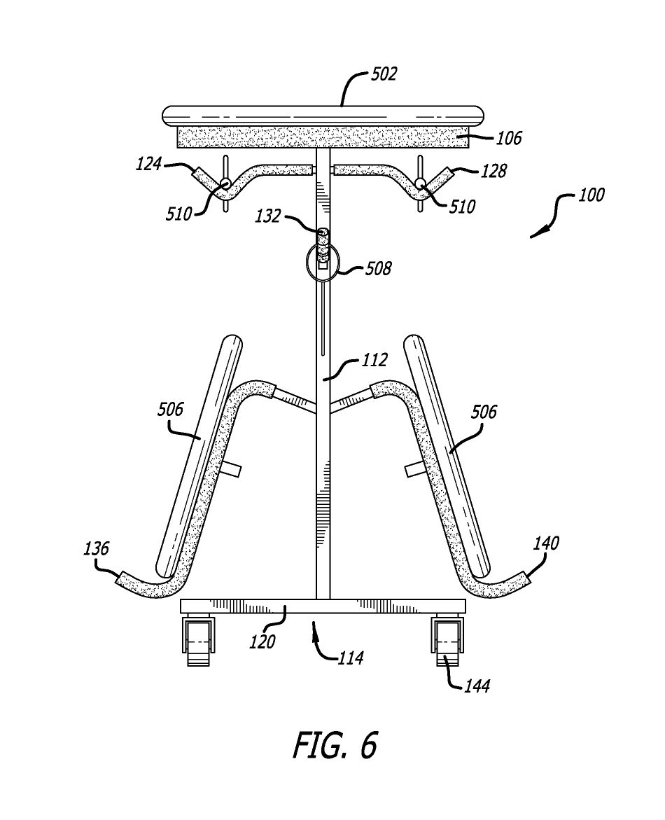

As illustrated in FIGS. 5 and 6, apparatus 100 can accommodate first board 502, second board 504, and third board 506. First board 502 can rest in a generally horizontal orientation on top deck area 104. Second board 504 can rest in a generally angled configuration on first angled elongated equipment deck support 136 and second angled elongated equipment deck support 138. Third board 506 can rest in a generally angled configuration on third angled elongated equipment deck support 140 and fourth angled elongated equipment deck support 142.

Any one of first board 502, second board 504, and third board 506 can be simply placed in its display location or can be secured thereto using any appropriate securing means known in the art. For example, a securing means can be a rope, string, bungee cord, rubber band, or the like. In some cases, gravity is used to hold the boards in place.

Other members on apparatus 100 can be used to hold board accessories such as, leashes, oars, fins, bathing suits, towels, wax, or the like. For example, first arm 132 or second arm 134 can be used to hold leash 508. In a configuration wherein one board may be a paddle board, third accessory hanger 128 and fourth accessory hanger 130 can be used to hold or support one or more oar 510.

Further, as described, cross bean 146 can have an adjustable length 512. The adjustable length 512 can allow for display of different length boards. For example, because many boards have one or more fin 514, in order to properly balance a board on apparatus 100, length 512 may need to be increased or decreased to allow a board to properly sit on top deck area 104 without interference from fin 514 hitting second perpendicular bar 108.

Brochures 516 can be displayed on apparatus 100 or from it, or on an individual board. Brochures 516 can be housed in any device that allows them to connect to apparatus 100. Brochures 516 can be attached to a board or attain a freestanding configuration. Brochures 516 can accompany each board to assist in educating the buyer. As the buyer may not have educational help from the self service retailer, in addition to the mere display of the products themselves, printed brochures can be attached to apparatus frame, for example, on first arm 132 and/or second arm 134. The brochure can be of any size that aids in the education and sale of the product. The size can be about 3×5 in, about 8.5×11 in, or the like. Bold colors and fonts can be used on or for the printed brochures. The brochure can include information about the product's price, weight, dimensions, use explanation, performance characteristics, preferred age range, precautions, use instructions, recommendations, recommended accessories, recommended upgrades, comparisons to competitor products, company profile, company history, explanation of company's role in the community, company's military affiliations, company's affiliation with charitable organizations, product awards, product reviews, critics' reviews, user reviews, other product colors, photos of product, photos of product in use, warranty information, warranty disclaimer, nature, building materials, recommended upkeep instructions, and the like.

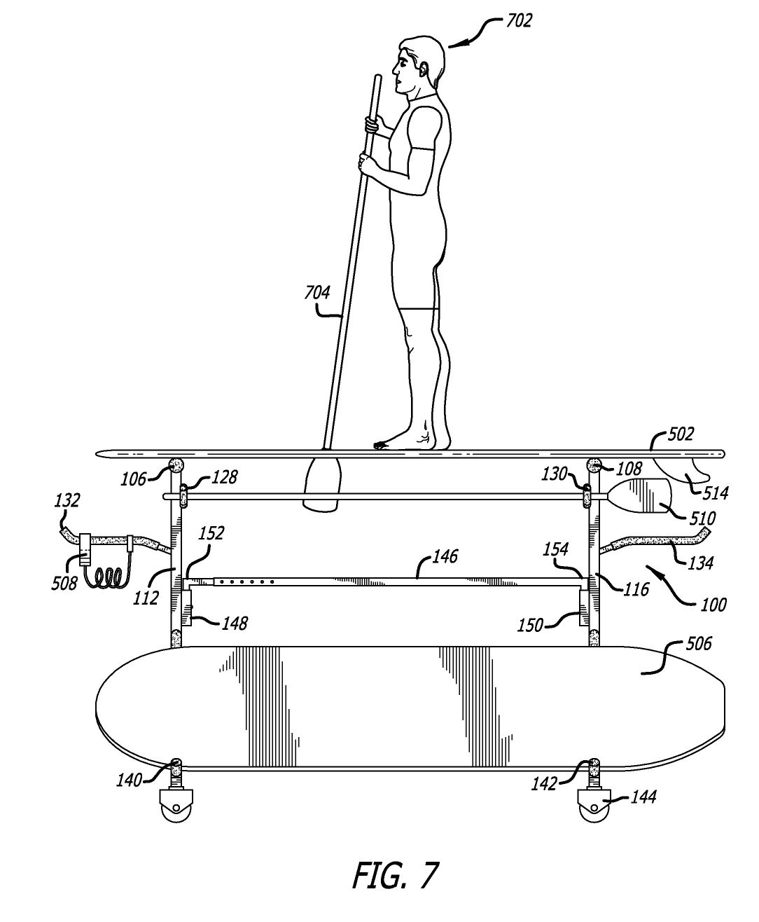

In another embodiment illustrated in FIG. 7, apparatus 100 can include first board 502, second board 504, and third board 506, but can also include at least one self selling prop 702. Specifically, in FIG. 7, self selling prop 702 is a mannequin oriented in a position of use. In FIG. 7, first board 502 is a paddle board and sell selling prop 702 is displayed in an in use position meaning the mannequin is standing and holding an oar 704. In another embodiment, if first board 502 was a surf board, the mannequin may assume an upright surfing position or a prone paddle surfing position. In any case, the self-selling prop 702 can be oriented in such a way as to educate the customer as to how the board may be used and/or aid her in deciding to purchase the board.

In still another embodiment, a self selling prop can be matched to a particular board. For example, if a store wants to sell more pink female boards, a female mannequin may be placed atop first board 502.

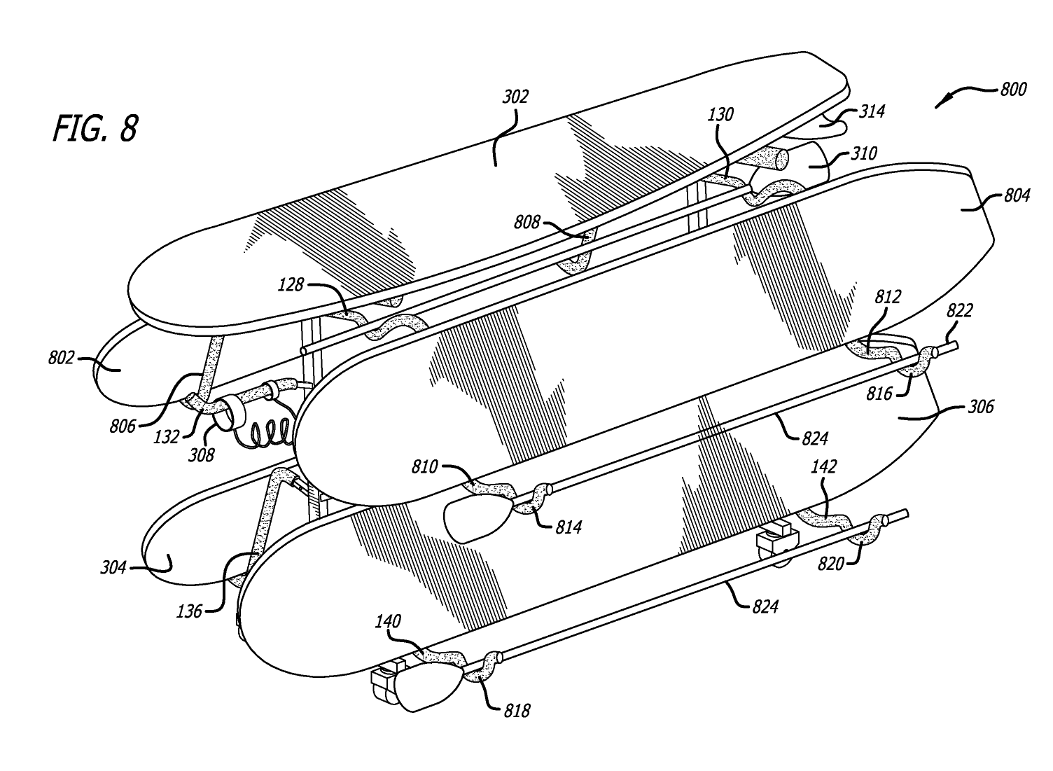

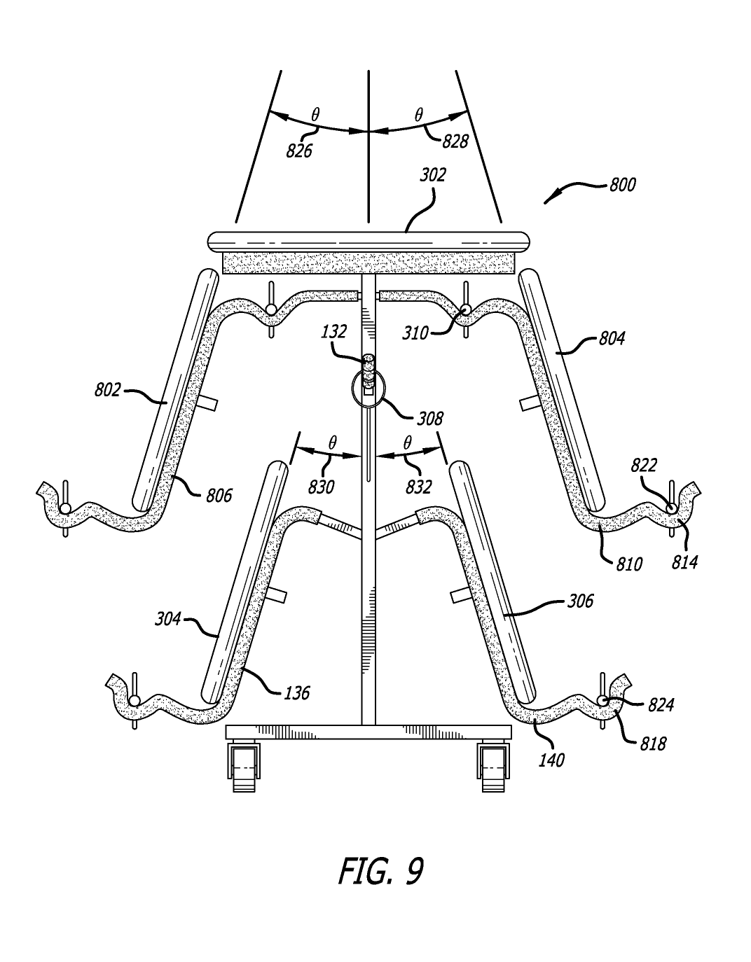

An alternate configuration is illustrated in FIGS. 8 and 9. Apparatus 800 can include some or all of the structural components of apparatus 100. However, apparatus 800 can further support fourth board 802 and fifth board 804. These boards can be displayed on extended versions of first accessory hanger 124, second accessory hanger 126, third accessory hanger 128, and fourth accessory hanger 130. First extension 806, second extension 808, third extension 810, and forth extension 812 can hold boards similar to first angled elongated equipment deck support 136, second angled elongated equipment deck support 138, third angled elongated equipment deck support 140, and fourth angled elongated equipment deck support 142.

Further, illustrated in apparatus 800, which can be a feature of apparatus 100 as well, fifth accessory hanger 814, sixth accessory hanger 816, seventh accessory hanger 818, and eight accessory hanger 820 can exist as extension to an angled elongated equipment deck support. For example, fifth accessory hanger 814 and sixth accessory hanger 816 can hold an accessory such as oar 822 and seventh accessory hanger 818 and eight accessory hanger 820 can hold another accessory such as oar 824.

Further, second board 304, third board 306, fourth board 802, and fifth board 804 can sit at first angle 826, second angle 828, third angle 830, or fourth angle 832. Third angle 830 and fourth angle 832 can be similar angles in apparatus 100 or even the same angles. Also, each opposite facing board can sit at an equal angle or a different angle depending on the particular apparatus being used. In any case, each of first angle 826, second angle 828, third angle 830, or fourth angle 832 can be about 10 degrees, about 20 degrees, about 25 degrees, about 30 degrees, about 35 degrees, about 40 degrees, about 45 degrees, about 50 degrees, about 55 degrees, about 60 degrees, about 65 degrees, about 70 degrees, about 75 degrees, about 80 degrees, about 85 degrees, or about 90 degrees, between about 20 degrees and about 90 degrees, between about 30 degrees and about 60 degrees, between about 20 degrees about 45 degrees. In some embodiments, all four angles are the same.

The assembly described herein can have security features associated with them. For example, the wheels can be locked with a key or combination that can prevent simply un-breaking the wheels and rolling the apparatus away without authorization. Also, elongated sporting equipment can be locked to the apparatus. For example, different members can have loops or other such devices that can allow elongated sporting boards to be locked to an apparatus.

Even further, an apparatus can include a lockable box mounted to it. Lockable box can hold valuables (e.g., car keys, wallet, etc.) while a user is using the elongated sporting board(s). Even further still, apparatus can include a box for storage of tools, waxes, first aid, etc. needed for sporting activity.

It should be appreciated that the apparatuses described herein may enable selling of elongated sporting equipment in a self service retailer. A self service retailer is a retail or warehouse location where a potential buyer of products has minimal or less than minimal input from any employees at the self service retailer. In such stores, a buyer may not even seek an employee for checkout; rather, the buyer may perform a self checkout using an in-store self checkout machine or a smartphone or tablet application. In some embodiments, the buyer has no interaction or input at all from any employees. Example self service retailers include, but are not limited to, military exchange stores (“PX stores”), warehouse retailers (e.g., Costco), liquidation stores, and the like.

In such, self service retailers, because the buyer has minimal to less than minimal contact with employees or even minimal or less than minimal interaction with employees that have knowledge of the products being sold, the products must in some cases sell themselves. As such, the present apparatus, e.g., apparatus 100, can present an elongated piece of sporting equipment in an orientation of use so the buyer at least understands how the product is used and realistically how large or small the object is.

One or more horizontal display orientations as described can aid a buyer in seeing the equipment at different angles and at different lighting conditions. Additionally, the vertical display orientations can allow the display of different color equipment or differently configured equipment for the self education of the buyer.

The minimalist design of apparatus 100 can aid in the education to the buyer of the light weight of the elongated sporting equipment. A buyer can be further assured that the sporting equipment is relatively light when resting on or in the present display apparatus and systems.

In one embodiment, an apparatus described herein can display to a buyer a piece of elongated sporting equipment, e.g., an elongated sporting board, on a self selling display frame including a top deck configured to horizontally support a first piece of elongated sporting equipment in an orientation of use and at least two angled side decks each independently configured to horizontally support an additional piece of elongated sporting equipment in a presentation orientation. The one or more presentation orientations can aid a buyer in seeing the equipment at different angles and at different lighting conditions. Additionally, the presentation orientations can allow the display of different color equipment or differently configured equipment for the self education of the buyer.

In one embodiment, where the piece of elongated sporting equipment is a surfboard or paddle board, for example, a board can be placed on the upper deck in the orientation of use. Further, a mannequin can be placed standing on top of the board in a position of use to further educate the buyer in how the product may be used. If the board is a paddle board, the mannequin can further be holding an oar to educate the buyer in how to use a paddle board. A mannequin can be used for any piece of elongated sporting equipment, surfboards and paddle boards are used for illustrative purposes only.

The minimalist design of apparatus 100 can aid in the education to the buyer of the light weight of the elongated sporting equipment. A buyer can be further assured that the sporting equipment is relatively light when resting on either top deck 104 or an angled side deck.

Methods of selling elongated sporting boards in a self service retailer are described. The methods include mounting at least one elongated sporting board on a self selling display frame such as apparatus 100 or 800. The self selling display frame can include a top deck configured to horizontally support a first elongated sporting board in an orientation of use and at least two angled side decks each independently configured to horizontally support an additional elongated sporting board in a presentation orientation. One elongated sporting boards are placed on the self selling display, the display can be rolled to a desired store location. As described herein, minimal or less than minimal input from the self service retailer about the elongated sporting board may be provided, requiring a buyer to self educate him/herself about the elongated sporting board. The methods can sell the at least one elongated sporting board to the buyer.

Use of the apparatus described herein to sell elongated sporting boards can increase sales by at least about 2%, at least about 4%, at least about 6%, at least about 8%, at least about 10%, at least about 15%, at least about 20%, at least about 25%, at least about 30%, at least about 40%, at least about 50%, about 2%, about 4%, about 6%, about 8%, about 10%, about 15%, about 20%, about 25%, about 30%, about 40%, about 50%, between about 2% and about 50%, between about 2% and about 25%, between about 2% and about 15%, between about 2% and about 10%, or between about 10% and about 40% annually.

### Example 1

### Portable Display Apparatus

A display such as apparatus 100 is assembled on sight and loaded with three elongated sporting boards and accompanying accessories. Once assembled and loaded, the apparatus can be moved to a desired location within a self service retailer and displayed for sale.

### Example 2

### Selling an Elongated Sporting Board

At least one elongated sporting board is mounted on a display apparatus as described. A pamphlet is associated with each board and a mannequin is placed atop the horizontal board on the top deck area. The apparatus is positioned in the sporting goods section of a self service retailer. A customer enters the self service retailer where employees have little or no knowledge of the products being sold. The customer is lured to an elongated sporting board by its display, he reads the pamphlet and understands the characteristics of the board based on the overall display, and without help from the self service retailer buys the elongated sporting board.

### Example 3

### Display Apparatus at a Paddleboard Rental Establishment

An apparatus as described is loaded with paddle boards and a mannequin in a position of use is placed at a paddleboard rental establishment to attract customers to rent boards. A customer approaches the rental establishment and sees the boards displayed. The customer is lured to a paddle board by its display, he reads the pamphlet and understands the characteristics of the board based on the overall display, and decides to rent a paddleboard for the afternoon.

### Example 4

### Apparatus at Beach

An apparatus as described is unloaded from a car trunk and assembled. Off road tires are installed on the apparatus. Surf boards are loaded on the apparatus and the entire loaded apparatus is rolled from the parking lot onto the sand. Once a desired location in the sand is found, the wheels' brakes are applied and boards are taken on and off the display as needed.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

I claim:

1. A mobile elongated sporting board rack system comprising:
a frame including:
(a) a top deck configured to horizontally support a first elongated sporting board in an orientation of use;
(b) a first angled side deck configured to horizontally support a second elongated sporting board in a first presentation orientation; and
(c) a second angled side deck configured to horizontally support a third elongated sporting board in a second presentation orientation.

2. The mobile elongated sporting board rack system of claim 1, further comprising at least one arm configured to mount an accessory.

3. The mobile elongated sporting board rack system of claim 1, further comprising at least one arm configured as a handle.

4. The mobile elongated sporting board rack system of claim 1, further comprising at least one pair of accessory hangers.

5. The mobile elongated sporting board rack system of claim 1, wherein the frame further includes a first mast; a second mast; and a cross beam oriented between the first mast and the second mast.

6. The mobile elongated sporting board rack system of claim 5, wherein the cross beam has an adjustable length.

7. The mobile elongated sporting board rack system of claim 6, wherein the first mast includes a first base comprising at least one first wheel and the second mast includes a second base comprising at least one second wheel.

8. The mobile elongated sporting board rack system of claim 1, wherein the frame further includes: (d) a third angled side deck configured to horizontally support a fourth elongated sporting board in a third presentation orientation; and (e) a fourth angled side deck configured to horizontally support a fifth elongated sporting board in a fourth presentation orientation.

9. A method of selling an elongated sporting board in a self service retailer comprising:
displaying to a buyer the elongated sporting board on a self selling display frame including a top deck configured to horizontally support a first elongated sporting board in an orientation of use and at least two angled side decks each independently configured to horizontally support an additional elongated sporting board in a presentation orientation; and
selling the at least one elongated sporting board to the buyer with minimal or less than minimal input from the self service retailer.

10. The method of claim 9, wherein the display frame includes an information pamphlet display.

11. The method of claim 9, wherein the self selling display frame further comprises at least one arm configured to mount an accessory or as a handle.

12. The method of claim 9, wherein the self selling display frame further comprises at least one pair of accessory hangers.

13. The method of claim 9, wherein the self selling display frame further includes a cross beam oriented between two masts.

14. The method of claim 9, wherein the elongated sporting board is a surfboard, a paddle board, a boogie board, a wake board, a knee board, a skim board, a snowboard, a skateboard, a roller board, a sled, or a combination thereof.

15. A method of presenting elongated sporting boards in a self service retailer comprising:
providing a self selling display frame including: (a) a top deck configured to horizontally support a first elongated sporting board in an orientation of use; (b) a first angled side deck configured to horizontally support a second elongated sporting board in a first presentation orientation; and (c) a second angled side deck configured to horizontally support a third elongated sporting board in a second presentation orientation;
presenting a buyer with an information pamphlet about the first elongated sporting board, the second elongated sporting board, and the third elongated sporting board; and
selling the at least one elongated sporting board to a buyer with minimal or less than minimal input from the self service retailer.

16. The method of claim 15, wherein the self selling display frame further comprises at least one pair of accessory hangers.

17. The method of claim 15, wherein the self selling display frame further includes a first mast; a second mast; and an adjustable length cross beam oriented between the first mast and the second mast.

18. The method of claim 15, wherein the frame further includes: (d) a third angled side deck configured to horizontally support a fourth elongated sporting board in a third presentation orientation; and (e) a fourth angled side deck configured to horizontally support a fifth elongated sporting board in a fourth presentation orientation.

19. The method of claim 15, wherein the elongated sporting board is a surfboard, a paddle board, a boogie board, a wake board, a knee board, a skim board, a snowboard, a skateboard, a roller board, a sled, or a combination thereof.

20. The method of claim 15, further comprising rolling the self selling display frame into a position within the self service retailer.
